(19) United States
(12) Patent Application Publication
(10) Pub. No.: US 2026/0037364 A1
(43) Pub. Date: Feb. 5, 2026

(54) USER INTERFACES FOR VISUALIZING REMEDIATION BACKLOGS

(71) Applicant: Capital One Services, LLC, McLean, VA (US)

(72) Inventors: Grant Michael IWAN, Montpelier, VA (US); Mohamed SECK, Aubrey, TX (US); Shannon REID, Richmond, VA (US); Ameesh PALEJA, Las Vegas, NV (US)

(21) Appl. No.: 18/790,581

(22) Filed: Jul. 31, 2024

(51) Int. Cl. G06F 11/07; G06Q 10/0631; G06Q 10/0639

(52) U.S. Cl. CPC G06F 11/0793; G06F 11/0766; G06Q 10/06311; G06Q 10/06314; G06Q 10/06393

(57) ABSTRACT

In some implementations, an administrator device may transmit, to a backlog system, a request to assess a set of remediation actions associated with an administrator indicated in the request and a set of credentials for a tracking system and associated with the administrator. The administrator device may receive, from the backlog system, instructions for a user interface (UI) indicating the set of remediation actions in an order determined by a machine learning model. Each remediation action may be represented in the UI adjacent to a status associated with the remediation action. Additionally, or alternatively, the administrator device may receive, from the backlog system, instructions for a UI depicting the set of remediation actions relative to a set of datetimes for the set of remediation actions and a set of categories for the set of remediation actions.

### BACKGROUND

Cloud-based applications may be associated with compliance activities. Compliance activities may include software updates and system refreshes, among other examples. Security vulnerabilities may arise when compliance activities are not performed. These vulnerabilities can result in downtime for the cloud-based applications.

### SUMMARY

Some implementations described herein relate to a system for providing user interfaces (UIs) to visualize a remediation backlog. The system may include one or more memories and one or more processors communicatively coupled to the one or more memories. The one or more processors may be configured to receive, from a tracking system, a set of data structures representing a set of respective remediation actions. The one or more processors may be configured to determine, for each remediation action, a score representing a level of effort associated with the remediation action. The one or more processors may be configured to provide, to a machine learning model, a set of datetimes from the set of data structures, a set of severity levels from the set of data structures, and the score for each remediation action, in order to receive an order for the set of respective remediation actions. The one or more processors may be configured to output, to an administrator device, instructions for a first UI indicating the set of respective remediation actions in the order from the machine learning model, wherein each remediation action is represented in the first UI adjacent to a status associated with the remediation action. The one or more processors may be configured to output, to the administrator device, instructions for a second UI depicting the set of respective remediation actions relative to the set of datetimes and a set of categories for the set of respective remediation actions.

Some implementations described herein relate to a method of providing UIs to visualize a remediation backlog. The method may include transmitting, from an administrator device and to a backlog system, a request to assess a set of remediation actions associated with an administrator indicated in the request. The method may include transmitting, from the administrator device and to the backlog system, a set of credentials for a tracking system and associated with the administrator. The method may include transmitting, from the administrator device and to the backlog system, an indication to use a list view for the set of remediation actions. The method may include receiving, from the backlog system and at the administrator device, instructions for a UI indicating the set of remediation actions in an order determined by a machine learning model, wherein each remediation action is represented in the UI adjacent to a status associated with the remediation action.

Some implementations described herein relate to a non-transitory computer-readable medium that stores a set of instructions for providing UIs to visualize a remediation backlog. The set of instructions, when executed by one or more processors of a device, may cause the device to transmit, to a backlog system, a request to assess a set of remediation actions associated with an administrator indicated in the request. The set of instructions, when executed by one or more processors of the device, may cause the device to transmit, to the backlog system, a set of credentials for a tracking system and associated with the administrator. The set of instructions, when executed by one or more processors of the device, may cause the device to transmit, to the backlog system, an indication to use a calendar view for the set of remediation actions. The set of instructions, when executed by one or more processors of the device, may cause the device to receive, from the backlog system, instructions for a UI depicting the set of remediation actions relative to a set of datetimes for the set of remediation actions and a set of categories for the set of remediation actions.

### BRIEF DESCRIPTION OF THE DRAWINGS

FIGS. 1A-1D are diagrams of an example implementation relating to generating and outputting UIs for visualizing remediation backlogs, in accordance with some embodiments of the present disclosure.

FIG. 2 is a diagram of an example UI relating to a list view for visualizing remediation backlogs, in accordance with some embodiments of the present disclosure.

FIG. 3 is a diagram of an example UI relating to a calendar view for visualizing remediation backlogs, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of one or more devices of FIG. 4, in accordance with some embodiments of the present disclosure.

FIGS. 6-7 are flowcharts of example processes relating to generating and outputting UIs for visualizing remediation backlogs, in accordance with some embodiments of the present disclosure.

### DETAILED DESCRIPTION

The following detailed description of example implementations refers to the accompanying drawings. The same reference numbers in different drawings may identify the same or similar elements.

In some cloud environments, application services (ASVs) or other cloud-based applications may be associated with compliance activities. Compliance activities may include certification of a set of team members, rehydration of a cloud storage, updating of a software application, review of an application profile, or registering a dataset, among other examples. Security vulnerabilities may arise when compliance activities are not performed. For example, software applications that are due for security patches or other software updates may be vulnerable to attacks, and drivers or other applications that control networked devices, at least in part, that are due for security patches or other software updates may be vulnerable to attacks.

Generally, administrators may perform compliance activities in an order in which the administrators are notified. However, some compliance activities are more likely to result in security vulnerabilities than other compliance activities. Accordingly, performing compliance activities as notified can reduce security by increasing chances of security vulnerabilities. The administrators may perform the compliance activities in order of notification because email messages about the compliance activities are sorted by order of receipt.

Some implementations described herein enable generation of a UI that orders remediation actions (e.g., associated with compliance activities and/or security vulnerabilities) based on machine learning. For example, a machine learning model may order the remediation actions using scores representing levels of effort associated with the remediation actions, datetimes associated with the remediation actions, and/or severity levels associated with the remediation actions. The UI may further represent the remediation actions, in the order from the machine learning model, adjacent to statuses associated with the remediation actions. As a result, an administrator is more likely to perform the remediation actions in a sequence that will result in greater security (e.g., fewer and/or less severe security vulnerabilities). Additionally, or alternatively, some implementations described herein enable generation of a UI that depicts the remediation actions relative to datetimes and categories for remediation actions. As a result, an administrator is more likely to perform overdue remediation actions and remediation actions in higher-priority categories, which will result in greater security (e.g., fewer and/or less severe security vulnerabilities).

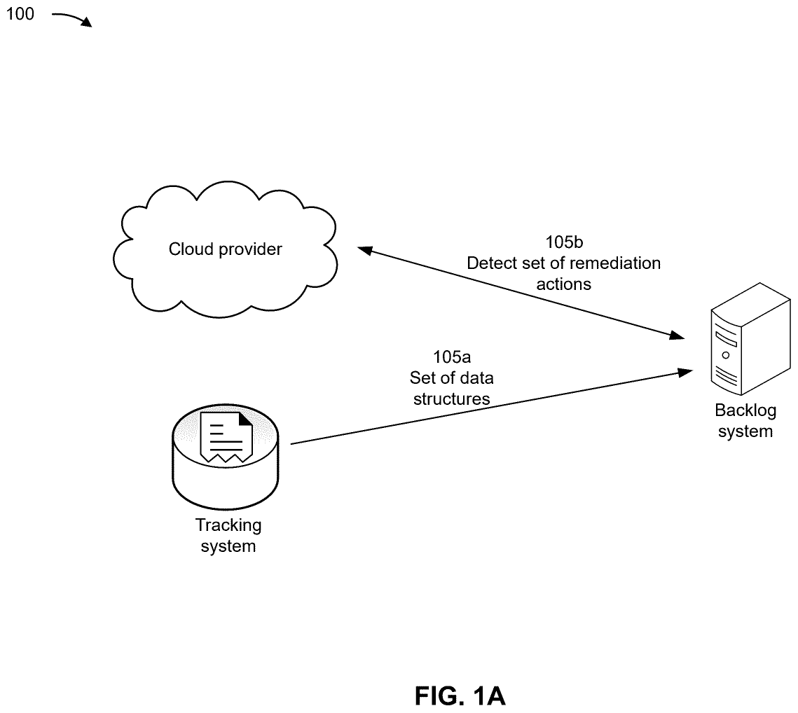

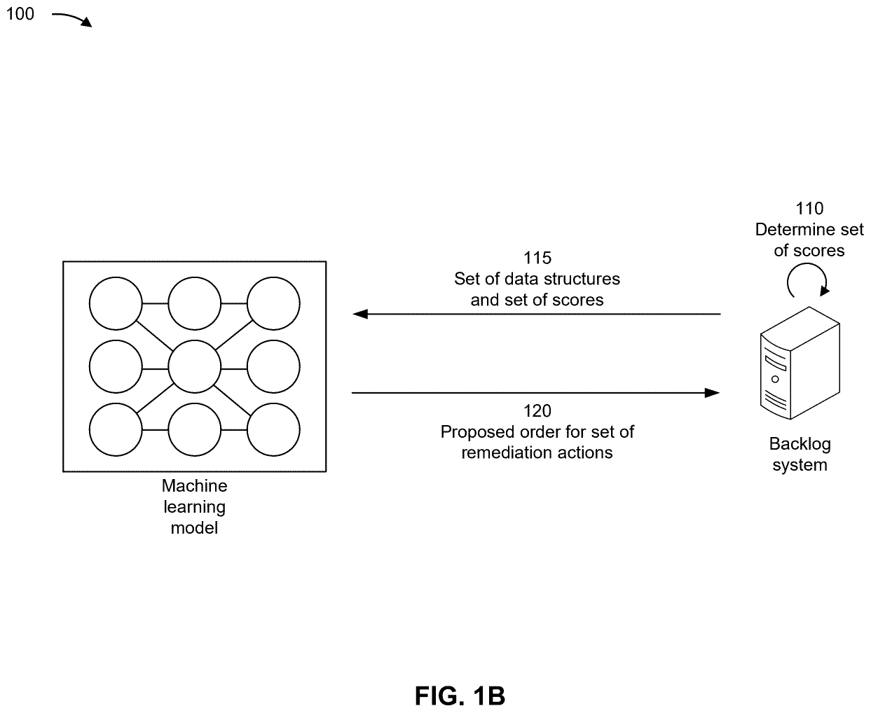

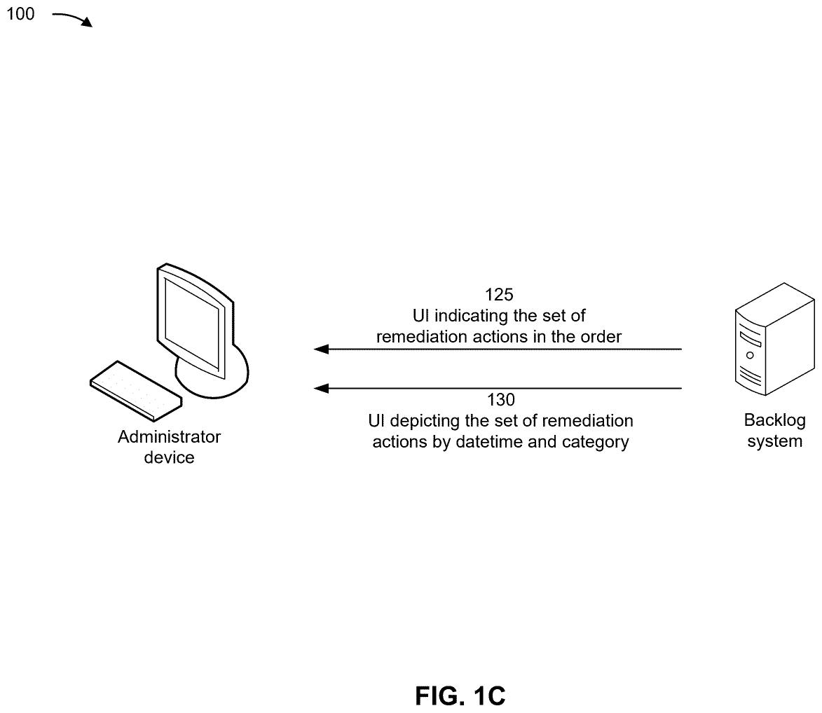

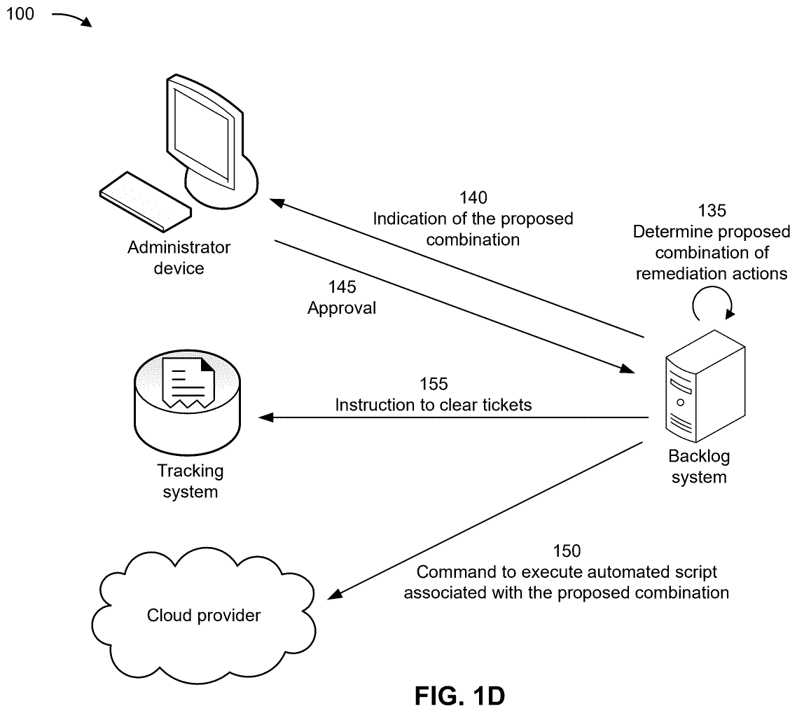

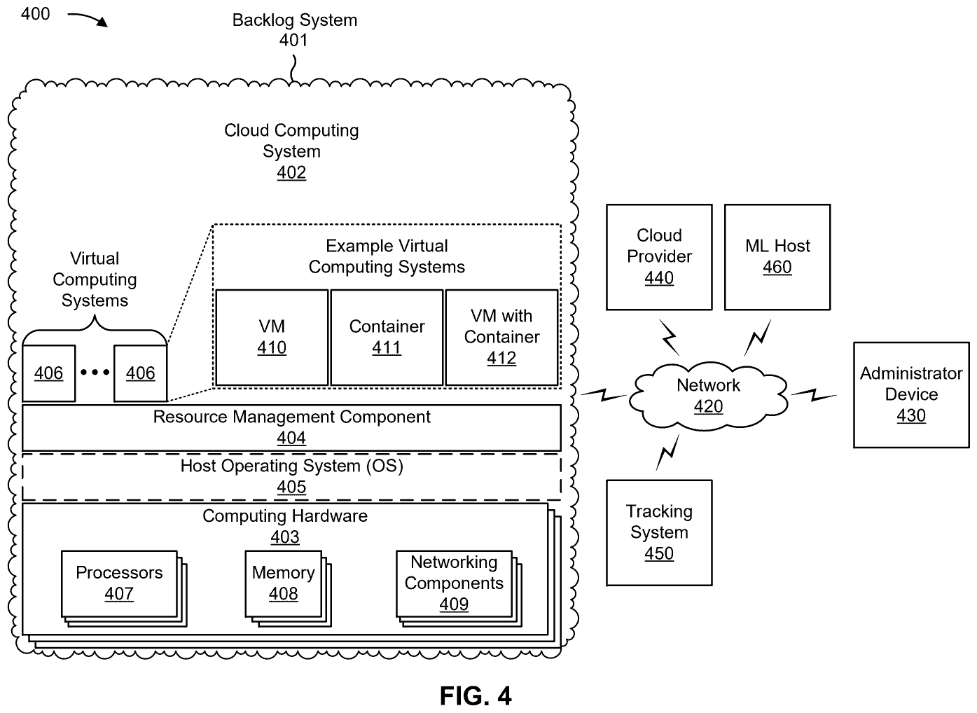

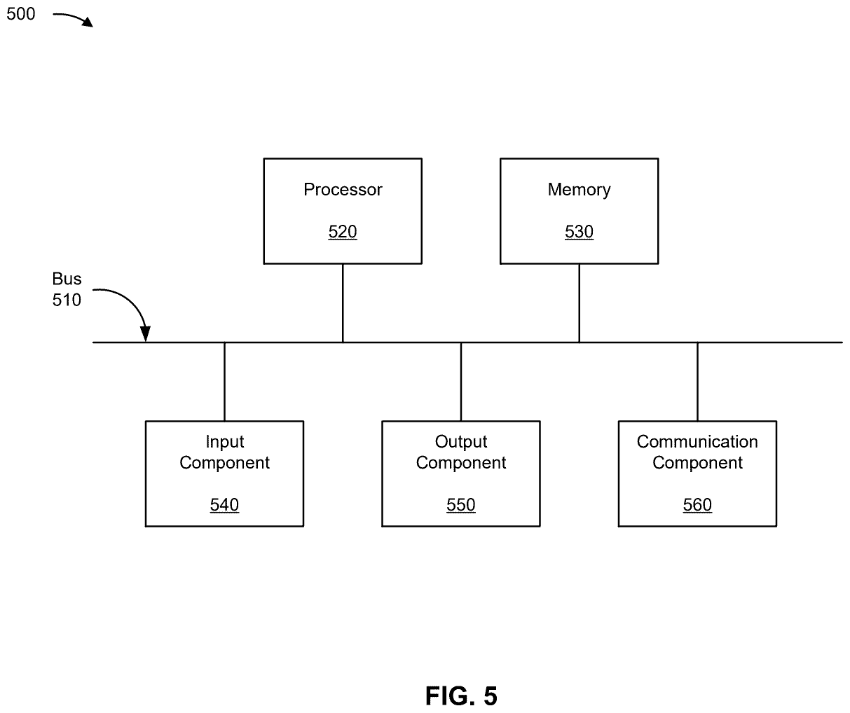

FIGS. 1A-1D are diagrams of an example 100 associated with user interfaces for visualizing remediation backlogs. As shown in FIGS. 1A-1D, example 100 includes a tracking system, a cloud provider, a backlog system, a machine learning (ML) model (e.g., provided by an ML host), and an administrator device. These devices are described in more detail in connection with FIGS. 4 and 5.

As shown in FIG. 1A and by reference number 105a, the tracking system may transmit, and the backlog system may receive, a set of data structures representing a set of respective remediation actions. The set of respective remediation actions may include security vulnerabilities (e.g., at least one security vulnerability) to be remediated and/or compliance activities (e.g., at least one compliance activity) to be completed. Accordingly, the set of data structures may represent tickets that are generated in response to non-performance of the compliance activities (e.g., automatically or by an administrator) and/or detection of the security vulnerabilities (e.g., automatically or by an administrator). Alternatively, the tickets may be generated as reminders to complete the compliance activities (e.g., automatically or by the administrator) and/or reminders to remediate the security vulnerabilities (e.g., automatically or by the administrator). In some implementations, the set of respective remediation actions may be indicated by names (e.g., string values). Additionally, or alternatively, the set of respective remediation actions may be associated with a corresponding set of datetimes (e.g., indicated in the set of data structures). Each datetime may indicate when performance of a corresponding remediation action is expected. Additionally, or alternatively, the set of respective remediation actions may be associated with a corresponding set of severity levels (e.g., indicated in the set of data structures). The severity levels may include numerical indicators (e.g., scores between 1 and 5, between 1 and 10, or in another numeric range) and/or categorical indicators (e.g., a selection between “high,” “medium,” and “low,” among other examples).

In some implementations, the backlog system may transmit, and the tracking system may receive, a request for the set of data structures. For example, the request may include a hypertext transfer protocol (HTTP) request, a file transfer protocol (FTP) request, and/or an application programming interface (API) call, among other examples. The request may include (e.g., in a header and/or as an argument) an indication of an administrator (or a team of administrators) assigned to the set of respective remediation actions. Accordingly, the tracking system may transmit the set of data structures in response to the request.

The backlog system may transmit the request according to a schedule (e.g., once per hour or once per day, among other examples) and/or in response to a command to transmit the request. For example, the administrator device may transmit, and the backlog system may receive, a request to assess the set of respective remediation actions, such that the backlog system transmits the request to the tracking system in response to the request from the administrator device. In some implementations, the administrator device may additionally transmit, and the backlog system may receive, a set of credentials for the tracking system. The administrator device may transmit the set of credentials in a same message as the request to assess the set of respective remediation actions or in a different message. Accordingly, the backlog system may transmit the set of credentials to the tracking system in order to access the set of data structures. The backlog system may transmit the set of credentials in a same message as the request for the set of data structures or in a different message.

Additionally, or alternatively, the backlog system may subscribe to ticket updates from the tracking system. Accordingly, the tracking system may transmit the set of data structures according to a schedule (e.g., once per hour or once per day, among other examples) and/or as available (e.g., shortly after new tickets are created).

Additionally, or alternatively, as shown by reference number 105b, the backlog system may detect, in coordination with the cloud provider, the set of respective remediation actions. In some implementations, the set of respective remediation actions may be indicated by names (e.g., string values). Additionally, or alternatively, the set of compliance activities and/or security vulnerabilities may be associated with a corresponding set of due dates (e.g., determined by the cloud provider). The set of respective remediation actions may, in some implementations, be associated with a corresponding set of datetimes and/or a corresponding set of severity levels (e.g., as described above in connection with reference number 105a).

In some implementations, the backlog system may transmit, and the cloud provider may receive, a request for the set of respective remediation actions. For example, the request may include an HTTP request and/or an API call, among other examples. The request may include (e.g., in a header and/or as an argument) an indication of an administrator (or a team of administrators) assigned to the set of respective remediation actions. Accordingly, the cloud provider may transmit an indication of the set of remediation actions in response to the request. The backlog system may transmit the request according to a schedule (e.g., once per hour or once per day, among other examples) and/or in response to a command to transmit the request. For example, the administrator device may transmit, and the backlog system may receive, a request for the set of respective remediation actions, such that the backlog system transmits the request to the tracking system in response to the request from the administrator device.

Additionally, or alternatively, the backlog system may subscribe to updates from the cloud provider. Accordingly, the cloud provider may transmit an indication of new remediation actions according to a schedule (e.g., once per hour or once per day, among other examples) and/or as available (e.g., shortly after a new compliance activity is added or a new security vulnerability is detected).

Although the example 100 is shown with the cloud provider and the tracking system, other examples may include an intermediary system (e.g., one or more intermediary devices) that receive and process information from the cloud provider and/or the tracking system. Accordingly, the backlog system may receive the set of data structures from the intermediary system. Additionally, or alternatively, the intermediary system may generate (or at least update) the set of data structures (e.g., based on the information received from the cloud provider and/or the tracking system). Accordingly, the backlog system may receive the set of data structures (or an updated set of data structures) from the intermediary system.

As shown in FIG. 1B and by reference number 110, the backlog system may determine a set of scores for the set of respective remediation actions. For example, the backlog system may determine, for each remediation action, a score representing a level of effort associated with the remediation action. Each score may therefore be an amount of time (e.g., for performing a corresponding remediation action). The backlog system may determine the set of scores based on the set of data structures. In some implementations, the backlog system may apply a model to determine the set of scores. For example, the backlog system may input the set of data structures (or information extracted from the set of data structures) to the model and receive an indication of the set of scores from the model. Additionally, or alternatively, the backlog system may map each remediation action to a corresponding sequence of events. The corresponding sequence of events may be included in a log, associated with historical remediation actions. The backlog system may identify the log to use for a remediation action based on similar names (e.g., a matching proportion of characters that satisfies a matching threshold, among other fuzzy matching techniques) associated with the log and the remediation action. In another example, the backlog system may use a clustering model to determine the log or logs that are similar to the remediation action. Therefore, the backlog system may determine, for each remediation action, a corresponding score based on the corresponding sequence of events (in the similar log).

As shown by reference number 115, the backlog system may provide, to the ML model, the set of data structures and the set of scores. For example, the backlog system may provide a set of datetimes from the set of data structures, a set of severity levels from the set of data structures, and the score for each remediation action. In some implementations, the backlog system may transmit, and the ML host associated with the ML model may receive, a request including the set of data structures and the set of scores. The ML model may be trained (e.g., by the ML host and/or a device at least partially separate from the ML host) to order remediation actions. The ML model may be trained using remediation actions that are labeled by administrators or other types of users (e.g., for supervised learning). Additionally, or alternatively, the ML model may be trained using remediation actions that are unlabeled (e.g., for deep learning). The ML model may be configured to determine a ranking or order for remediation actions (e.g., using datetimes associated with the remediation actions, severity levels associated with the remediation actions, and scores for the remediation actions).

In some implementations, the ML model may include a regression algorithm (e.g., linear regression or logistic regression), which may include a regularized regression algorithm (e.g., Lasso regression, Ridge regression, or Elastic-Net regression). Additionally, or alternatively, the ML model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., information about front-end devices). For example, for a regression algorithm, a model parameter may include a regression coefficient (e.g., a weight). For a decision tree algorithm, a model parameter may include a decision tree split location, as an example.

Additionally, the ML host (and/or a device at least partially separate from the ML host) may use one or more hyperparameter sets to tune the ML model. A hyperparameter may include a structural parameter that controls execution of a machine learning algorithm by the ML host, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

As shown by reference number 120, the ML model may output a proposed order for the set of respective remediation actions. For example, the backlog system may receive the proposed order from the ML model (e.g., from the ML host). The proposed order may be encoded in a data structure that links ordinal indicators (e.g., an indicator of first, an indicator of second, and so on) to indicators of remediation actions in the set of respective remediation actions (e.g., names, indices, and/or other types of alphanumeric identifiers). The ML model may place remediation actions associated with more recent datetimes and higher severity levels above remediation actions associated with datetimes that are further away and lesser severity levels. Additionally, the ML model may place remediation actions associated with lower scores above remediation actions associated with higher scores. For example, the ML model may prioritize security vulnerabilities that are easier to fix and compliance activities that are faster to complete above security vulnerabilities that are harder to fix and compliance activities that are slower to complete.

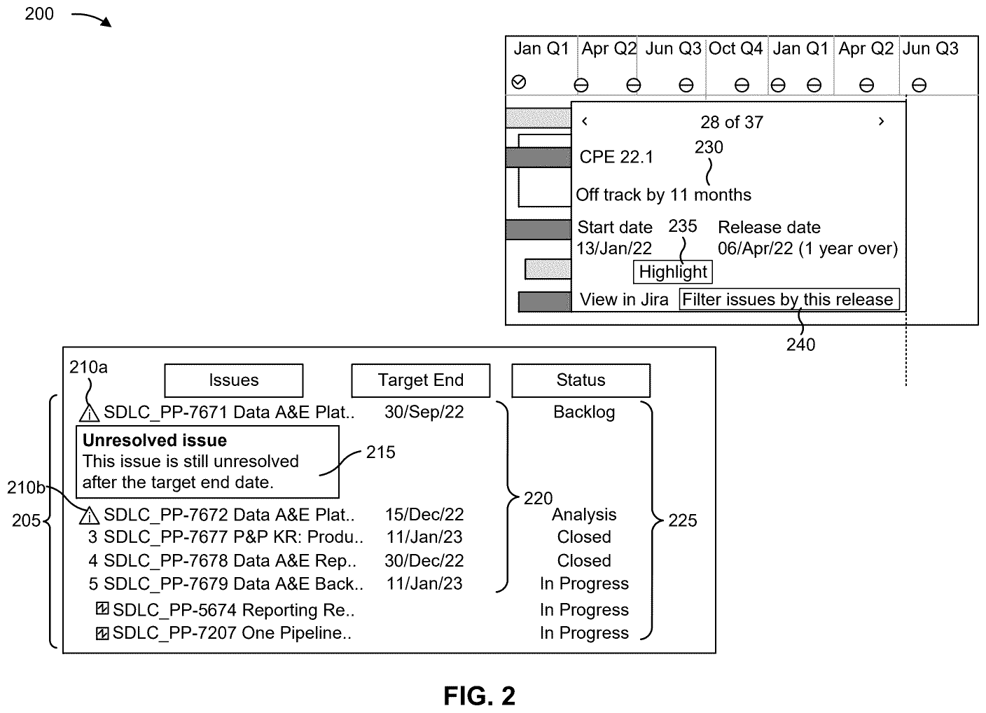

As shown in FIG. 1C and by reference number 125, the backlog system may transmit, and the administrator device may receive, instructions for a UI that indicates the set of respective remediation actions in the proposed order from the ML model. The UI may be as described in connection with FIG. 2. As described in connection with FIG. 2, each remediation action may be represented in the UI adjacent to a status associated with the remediation action. Additionally, as further described in connection with FIG. 2, the UI may indicate a difference between a total score associated with a remediation team including the administrator and a summation of scores for the set of remediation actions. Additionally, or alternatively, as described in connection with FIG. 2, the UI may indicate a difference between a predicted schedule for a remediation team including the administrator and an estimated timeline for the set of remediation actions.

In some implementations, the administrator device may transmit, and the backlog system may receive, an indication to use a list view (for the set of respective remediation actions). Accordingly, the backlog system may transmit, and the administrator device may receive, the instructions for the UI in response to the indication. The indication may be included in the request to assess the set of respective remediation actions or in a different message. In one example, an administrator using the administrator device may provide input (e.g., via an input component of the administrator device) that triggers the administrator device to transmit the indication.

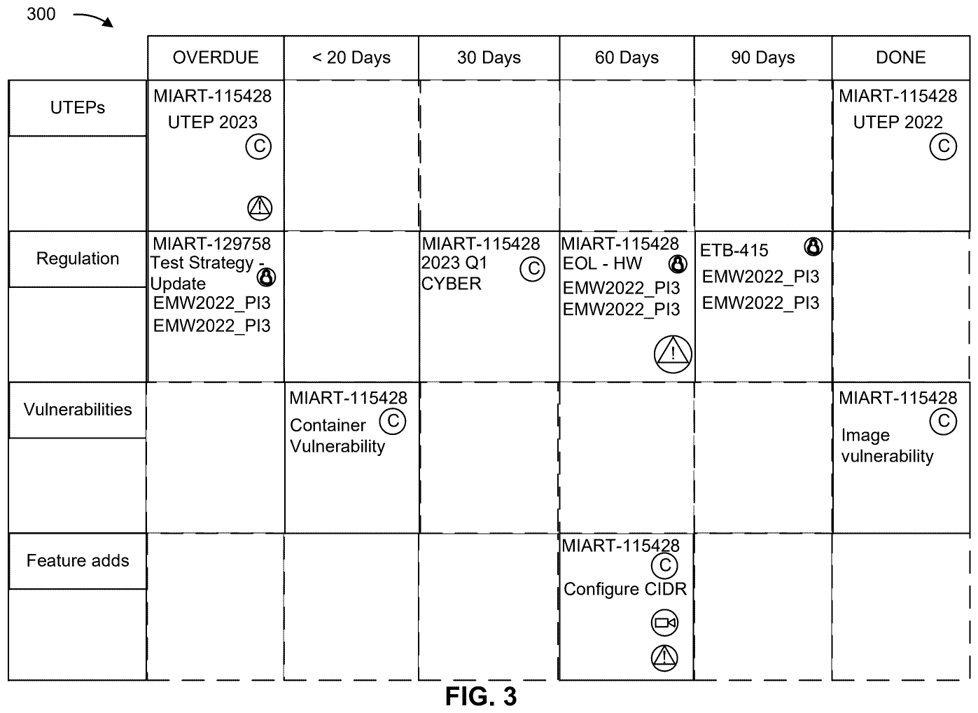

As shown by reference number 130, the backlog system may transmit, and the administrator device may receive, instructions for a UI depicting the set of respective remediation actions relative to the set of datetimes and a set of categories for the set of respective remediation actions. The UI may be as described in connection with FIG. 3.

In some implementations, the administrator device may transmit, and the backlog system may receive, an indication to use a calendar view (for the set of respective remediation actions). Accordingly, the backlog system may transmit, and the administrator device may receive, the instructions for the UI in response to the indication. The indication may be included in the request to assess the set of respective remediation actions or in a different message. In one example, an administrator using the administrator device may provide input (e.g., via an input component of the administrator device) that triggers the administrator device to transmit the indication. In some implementations, the administrator using the administrator device may pivot between the list view and the calendar view.

As shown in FIG. 1D and by reference number 135, the backlog system may determine a suggested combination of remediation actions (e.g., two or more remediation actions) in the set of remediation actions. For example, the backlog system may use a data structure that maps identifiers of remediation actions (e.g., names and/or other alphanumeric identifiers) to proposed combinations of remediation actions. Additionally, or alternatively, the backlog system may provide the set of data structures to an additional ML model (e.g., similar to the ML model described above) in order to receive an indication of the suggested combination. For example, the backlog system may transmit a request including the set of data structures to an additional ML host associated with the additional ML model, and the backlog system may receive the indication of the suggested combination from the additional ML host. Although the example 100 is described in connection with a different ML model and a different ML host, other examples may include the same ML model determining the order and the suggested combination, or the same ML host providing the ML model determining the order and the additional ML model determining the suggested combination.

In some implementations, the suggested combination may be based on a determination that resolving one remediation action will automatically resolve a different remediation action. For example, performing an update to a first cloud application may resolve a security vulnerability associated with the first cloud application as well as another security vulnerability associated with a second cloud application that depends on the first cloud application. Additionally, or alternatively, the suggested combination may be associated with a suggested automated script. For example, the script may trigger execution of a series of tasks that performs multiple remediation actions (e.g., refreshing multiple cloud images or scanning multiple code packages). In a combinatory example, one remediation action may be associated with deployment of the suggested automated script, and thus deployment of the suggested automated script may further complete remediation actions that are automatically completed based on execution of the suggested automated script.

The backlog system may output an indication of the suggested combination. For example, as shown by reference number 140, the backlog system may transmit, and the administrator device may receive, the indication of the suggested combination. The suggested combination may be associated with a suggested automated script, as described above, such that the backlog system may transmit, and the administrator device may receive, an indication of the suggested automated script.

As shown by reference number 145, the administrator device may transmit, and the backlog system may receive, an approval of the suggested combination. In some implementations, the administrator using the administrator device may provide input (e.g., via an input component of the administrator device) that triggers the administrator device to transmit the approval. For example, the administrator may interact with the indication of the suggested combination (e.g., output via an output component of the administrator device) in order to provide the input. The suggested combination may be associated with a suggested automated script, as described above, such that the administrator device may transmit, and the backlog system may receive, an approval of the suggested automated script.

The backlog system may execute the automated script (e.g., in response to the approval). In some implementations, as shown by reference number 150, the backlog system may transmit, and the cloud provider may receive, a command to execute the automated script. In some implementations, the backlog system may additionally transmit, and the cloud provider may additionally receive, the automated script. Alternatively, the command may indicate the automated script, and the cloud provider may retrieve the automated script based on the command.

As shown by reference number 155, the backlog system may transmit, and the tracking system may receive, an instruction to clear tickets (e.g., one or more tickets) associated with the remediation actions in the suggested combination. For example, the backlog system may transmit the instruction in response to transmitting the command to the cloud provider (to execute the automated script). Additionally, or alternatively, the cloud provider may transmit (and the backlog system may receive) an indication that the automated script completed execution, and the backlog system may transmit the instruction in response to the indication from the cloud provider.

In some implementations, the tracking system may transmit, and the administrator device may receive, an indication that a ticket, associated with a remediation action in the set of remediation actions, has been cleared by the backlog system. For example, the tracking system may transmit, and the administrator device may receive, an indication that the tickets, associated with the remediation actions in the suggested combination, have been cleared. In some implementations, the backlog system may transmit the indication in response to transmitting the instruction to the tracking system (to clear the tickets). Additionally, or alternatively, the tracking system may transmit (and the backlog system may receive) an indication that the tickets were cleared, and the backlog system may transmit the indication to the administrator device in response to the indication from the tracking system.

In some implementations, the backlog system may additionally receive calendar information associated with the administrator (e.g., who is assigned to one or more remediation actions in the set of respective remediation actions). As described in connection with FIG. 2, the calendar information may indicate meetings, holidays, and/or leave, among other examples, associated with the administrator. The backlog system may output an alert (e.g., at least one alert) based on the calendar information. For example, the backlog system may transmit, and the administrator device may receive, the alert. The alert may indicate that a remediation action (in the set of remediation actions) assigned to the administrator is associated with a datetime that falls within a holiday and/or leave for the administrator. Therefore, the administrator is aware that the remediation action is to be performed before the holiday and/or before starting the leave.

Additionally, or alternatively, the backlog system may receive a total score associated with a remediation team. For example, the backlog system may calculate the total score (e.g., as described in connection with FIG. 2) or may receive the total score from an external storage (e.g., controlled by, or at least associated with, the intermediary system, as described above). The backlog system may output an indication of a difference between the total score associated with the remediation team and a summation of scores for the set of respective remediation actions (e.g., as described in connection with FIG. 2). For example, the backlog system may transmit, and the administrator device may receive, the indication of the difference. Therefore, the administrator may determine whether additional automated scripts and/or additional workers are needed based on the difference.

By using techniques as described in connection with FIGS. 1A-1D, the backlog system may output instructions for a UI representing the set of remediation actions (e.g., associated with compliance activities and/or security vulnerabilities) in an order based on machine learning. The UI may further represent the remediation actions, in the order from the machine learning model, adjacent to statuses associated with the remediation actions. As a result, the administrator is more likely to perform the remediation actions in a sequence that will result in greater security (e.g., fewer and/or less severe security vulnerabilities). Additionally, the backlog system may output instructions for a UI that depicts the set of remediation actions relative to the set of datetimes and the set of categories. As a result, the administrator is more likely to perform overdue remediation actions and remediation actions in higher-priority categories, which will result in greater security (e.g., fewer and/or less severe security vulnerabilities).

As indicated above, FIGS. 1A-1D are provided as an example. Other examples may differ from what is described with regard to FIGS. 1A-1D.

FIG. 2 is a diagram of an example UI 200 associated with a list view for visualizing remediation backlogs. The example UI 200 may be output by an administrator device (e.g., based on instructions from a backlog system). These devices are described in more detail in connection with FIGS. 4 and 5.

As shown in FIG. 2, the example UI 200 may include a list 205 of a set of remediation actions. The list 205 may include standalone remediation actions (e.g., “SDLC_PP-7671,” “SDLC_PP-7672,” “SDLC_PP-7677,” and “SDLC_PP-7678” in FIG. 2) and/or remediation actions that are grouped under a same project (e.g., “SDLC_PP-5674” and “SDLC_PP-7207” are both grouped under “SDLC_PP-7679” in FIG. 2). The list 205 may include the set of remediation actions in an order determined by a machine learning model (e.g., as described in connection with FIGS. 1B-1C). Additionally, the example UI 200 may include a visual indicator of urgency for top-ranked remediation actions (e.g., visual indicators 210a and 210b in FIG. 2). A user may interact with a visual indicator (e.g., the visual indicator 210a) in order to trigger a pop-up window (e.g., window 215) with a message associated with the remediation action for the visual indicator. Other remediation actions may be represented adjacent to a numerical representation of order (e.g., “3,” “4”, and “5” in FIG. 2).

As further shown in FIG. 2, the example UI 200 may include a list 220 of a set of datetimes associated with the set of remediation actions. Therefore, the set of datetimes may be represented adjacent to the set of remediation actions. The example UI 200 may further include a list 225 of a set of statuses associated with the set of remediation actions. Therefore, the set of statuses may be represented adjacent to the set of remediation actions.

In FIG. 2, the example UI 200 may include an indication 230 of a difference between a predicted schedule for a remediation team and an estimated timeline for the set of remediation actions. In some implementations, the backlog system may use the set of datetimes to determine the difference. For example, the difference may be a sum of differences between datetimes (in the set of datetimes) that are passed and a current datetime. Additionally, or alternatively, the backlog system may sum a set of scores (e.g., representing levels of effort, as described in connection with FIG. 1B) for uncompleted remediation actions (in the set of remediation actions) to determine the difference.

Additionally, or alternatively, the example UI 200 may include an indication of a difference between a total score associated with the remediation team and a summation of scores for the set of remediation actions. For example, the backlog system may sum a total amount of available man-hours for the remediation team (e.g., based on calendar information from the remediation team indicating meetings, holidays, and/or leave, among other examples) to determine the total score associated with the remediation team. The backlog system may calculate the difference between a sum of the set of scores (e.g., representing levels of effort, as described in connection with FIG. 1B) for the set of remediation actions and the total score associated with the remediation team.

As further shown in FIG. 2, the example UI 200 may include an element 235 (e.g., a button) that causes a modification to the example UI 200 to highlight, in the list 205, remediation actions (in the set of remediation actions) associated with a particular project or team (e.g., a project or team associated with the indication 230). Similarly, the example UI 200 may include an element 240 (e.g., a button) that causes a modification to the example UI 200 to reduce the list 205 to include only remediation actions (in the set of remediation actions) associated with a particular project or team (e.g., a project or team associated with the indication 230).

As indicated above, FIG. 2 is provided as an example. Other examples may differ from what is described with regard to FIG. 2. For example, other UIs may include additional remediation actions or fewer remediation actions. Additionally, or alternatively, other UIs may include all standalone remediation actions or all grouped remediation actions.

FIG. 3 is a diagram of an example UI 300 associated with a calendar view for visualizing remediation backlogs. The example UI 300 may be output by an administrator device (e.g., based on instructions from a backlog system). These devices are described in more detail in connection with FIGS. 4 and 5.

As shown in FIG. 3, the example UI 300 may sort columns according to datetimes (e.g., “OVERDUE,” “<20 days,” “30 days,” “60 days,” “90 days,” and “DONE”). Therefore, a set of remediation actions may be represented in corresponding columns based on a set of datetimes associated with the set of remediation actions. Additionally, the example UI 300 may sort rows according to categories (e.g., unified technology exception program exceptions (“UTEPs”), “Regulation” activities, “Vulnerabilities,” and feature additions (“Feature adds”), among other examples). Therefore, the set of remediation actions may be represented in corresponding rows based on a set of categories associated with the set of remediation actions.

As indicated above, FIG. 3 is provided as an example. Other examples may differ from what is described with regard to FIG. 3. For example, rows may be sorted by datetimes, and columns may be sorted by categories.

FIG. 4 is a diagram of an example environment 400 in which systems and/or methods described herein may be implemented. As shown in FIG. 4, environment 400 may include a backlog system 401, which may include one or more elements of and/or may execute within a cloud computing system 402. The cloud computing system 402 may include one or more elements 403-412, as described in more detail below. As further shown in FIG. 4, environment 400 may include a network 420, an administrator device 430, a cloud provider 440, a tracking system 450, and/or an ML host 460. Devices and/or elements of environment 400 may interconnect via wired connections and/or wireless connections.

The cloud computing system 402 may include computing hardware 403, a resource management component 404, a host operating system (OS) 405, and/or one or more virtual computing systems 406. The cloud computing system 402 may execute on, for example, an Amazon Web Services platform, a Microsoft Azure platform, or a Snowflake platform. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

The computing hardware 403 may include hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, and/or one or more networking components 409. Examples of a processor, a memory, and a networking component (e.g., a communication component) are described elsewhere herein.

The resource management component 404 may include a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 410. Additionally, or alternatively, the resource management component 404 may include a container manager, such as when the virtual computing systems 406 are containers 411. In some implementations, the resource management component 404 executes within and/or in coordination with a host operating system 405.

A virtual computing system 406 may include a virtual environment that enables cloud-based execution of operations and/or processes described herein using computing hardware 403. As shown, a virtual computing system 406 may include a virtual machine 410, a container 411, or a hybrid environment 412 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

Although the backlog system 401 may include one or more elements 403-412 of the cloud computing system 402, may execute within the cloud computing system 402, and/or may be hosted within the cloud computing system 402, in some implementations, the backlog system 401 may not be cloud-based (e.g., may be implemented outside of a cloud computing system) or may be partially cloud-based. For example, the backlog system 401 may include one or more devices that are not part of the cloud computing system 402, such as device 500 of FIG. 5, which may include a standalone server or another type of computing device. The backlog system 401 may perform one or more operations and/or processes described in more detail elsewhere herein.

The network 420 may include one or more wired and/or wireless networks. For example, the network 420 may include a cellular network, a public land mobile network (PLMN), a local area network (LAN), a wide area network (WAN), a private network, the Internet, and/or a combination of these or other types of networks. The network 420 enables communication among the devices of the environment 400.

The administrator device 430 may include one or more devices capable of receiving, generating, storing, processing, and/or providing information associated with remediation actions, as described elsewhere herein. The administrator device 430 may include a communication device and/or a computing device. For example, the administrator device 430 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The administrator device 430 may communicate with one or more other devices of environment 400, as described elsewhere herein.

The cloud provider 440 may include one or more devices capable of receiving, generating, storing, processing, providing, and/or routing information associated with cloud-based applications and/or storages, as described elsewhere herein. The cloud provider 440 may include computing hardware used in a cloud computing environment. Additionally, or alternatively, the cloud provider 440 may include one or more devices that are not part of a cloud computing system, such as device 500 of FIG. 5, which may include a standalone server or another type of computing device. For example, the cloud provider 440 may include a server, such as an application server, a client server, a web server, a database server, a host server, a proxy server, a virtual server (e.g., executing on computing hardware), or a server in a cloud computing system. The cloud provider 440 may communicate with one or more other devices of environment 400, as described elsewhere herein.

The tracking system 450 may include one or more devices capable of receiving, generating, storing, processing, and/or providing information associated with tickets, as described elsewhere herein. The tracking system 450 may include a communication device and/or a computing device. For example, the tracking system 450 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The tracking system 450 may include an issue tracking system, such as Jira® or Bugzilla®, among other examples. The tracking system 450 may communicate with one or more other devices of environment 400, as described elsewhere herein.

The ML host 460 may include one or more devices capable of receiving, generating, storing, processing, and/or providing information associated with machine learning models, as described elsewhere herein. The ML host 460 may include a communication device and/or a computing device. For example, the ML host 460 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 460 may communicate with one or more other devices of environment 400, as described elsewhere herein.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of the environment 400 may perform one or more functions described as being performed by another set of devices of the environment 400.

FIG. 5 is a diagram of example components of a device 500 associated with UIs for visualizing remediation backlogs. The device 500 may correspond to an administrator device 430, a cloud provider 440, a tracking system 450, and/or an ML host 460. In some implementations, an administrator device 430, a cloud provider 440, a tracking system 450, and/or an ML host 460 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

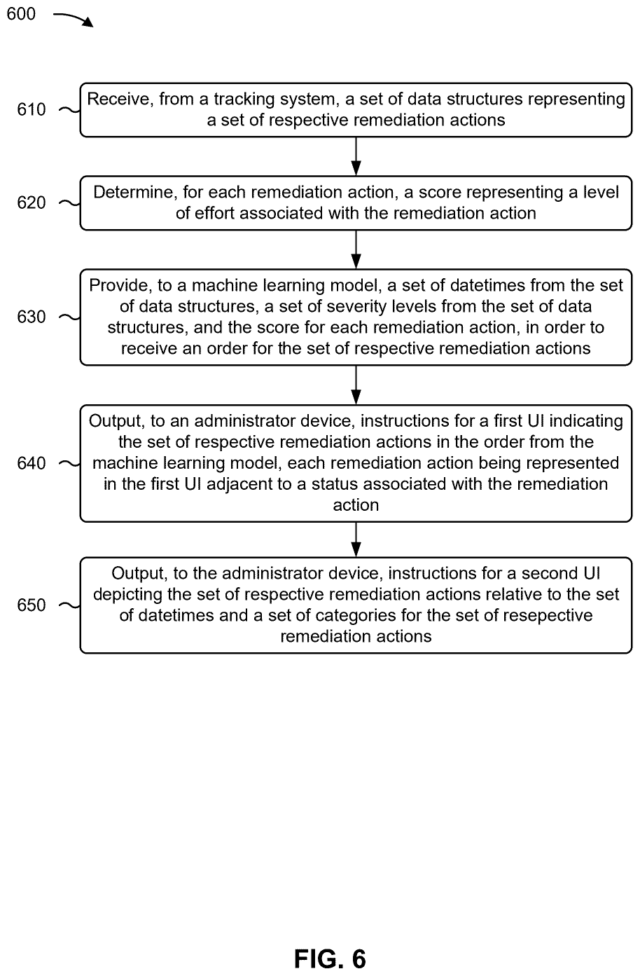

FIG. 6 is a flowchart of an example process 600 associated with generating UIs for visualizing remediation backlogs. In some implementations, one or more process blocks of FIG. 6 may be performed by a backlog system 401. In some implementations, one or more process blocks of FIG. 6 may be performed by another device or a group of devices separate from or including the backlog system 401, such as an administrator device 430, a cloud provider 440, a tracking system 450, and/or an ML host 460. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving, from a tracking system, a set of data structures representing a set of respective remediation actions (block 610). For example, the backlog system 401 (e.g., using processor 520, memory 530, and/or communication component 560) may receive, from a tracking system, a set of data structures representing a set of respective remediation actions, as described above in connection with reference number 105a of FIG. 1A. As an example, the set of data structures may represent tickets that were generated in response to non-performance of compliance activities (e.g., in the set of respective remediation actions) and/or detection of security vulnerabilities (e.g., associated with the set of respective remediation actions). Alternatively, the tickets may have been generated as reminders to complete the compliance activities (e.g., automatically or by an administrator) and/or reminders to remediate the security vulnerabilities (e.g., automatically or by the administrator).

As further shown in FIG. 6, process 600 may include determining, for each remediation action, a score representing a level of effort associated with the remediation action (block 620). For example, the backlog system 401 (e.g., using processor 520, memory 530, and/or communication component 560) may determine, for each remediation action, a score representing a level of effort associated with the remediation action, as described above in connection with reference number 110 of FIG. 1B. As an example, the backlog system 401 may apply a model (e.g., by transmitting the set of data structures to an ML host associated with the model) to determine the set of scores (e.g., received from the ML host associated with the model). Additionally, or alternatively, the backlog system 401 may map each remediation action to a corresponding sequence of events in order to determine the score for the remediation action.

As further shown in FIG. 6, process 600 may include providing, to a machine learning model, a set of datetimes from the set of data structures, a set of severity levels from the set of data structures, and the score for each remediation action, in order to receive an order for the set of respective remediation actions (block 630). For example, the backlog system 401 (e.g., using processor 520, memory 530, and/or communication component 560) may provide, to a machine learning model, a set of datetimes from the set of data structures, a set of severity levels from the set of data structures, and the score for each remediation action, in order to receive an order for the set of respective remediation actions, as described above in connection with reference numbers 115 and 120 of FIG. 1B. As an example, the machine learning model may be configured to determine the order (e.g., a ranking) for the set of respective remediation actions (e.g., using the set of datetimes, the set of severity levels, and the score for each remediation action).

As further shown in FIG. 6, process 600 may include outputting, to an administrator device, instructions for a first UI indicating the set of respective remediation actions in the order from the machine learning model, each remediation action being represented in the first UI adjacent to a status associated with the remediation action (block 640). For example, the backlog system 401 (e.g., using processor 520, memory 530, and/or communication component 560) may output, to an administrator device, instructions for a first UI indicating the set of respective remediation actions in the order from the machine learning model, each remediation action being represented in the first UI adjacent to a status associated with the remediation action, as described above in connection with FIG. 2. As an example, the first UI may include a list of the set of respective remediation actions adjacent to a list of a set of statuses (and adjacent to a list of the set of datetimes).

As further shown in FIG. 6, process 600 may include outputting, to the administrator device, instructions for a second UI depicting the set of respective remediation actions relative to the set of datetimes and a set of categories for the set of respective remediation actions (block 650). For example, the backlog system 401 (e.g., using processor 520, memory 530, and/or communication component 560) may output, to the administrator device, instructions for a second UI depicting the set of respective remediation actions relative to the set of datetimes and a set of categories for the set of respective remediation actions, as described above in connection with FIG. 3. As an example, the set of datetimes may be used to organize columns of the second UI, and the set of categories may be used to organize rows of the second UI.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1D, 2, and/or 3. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

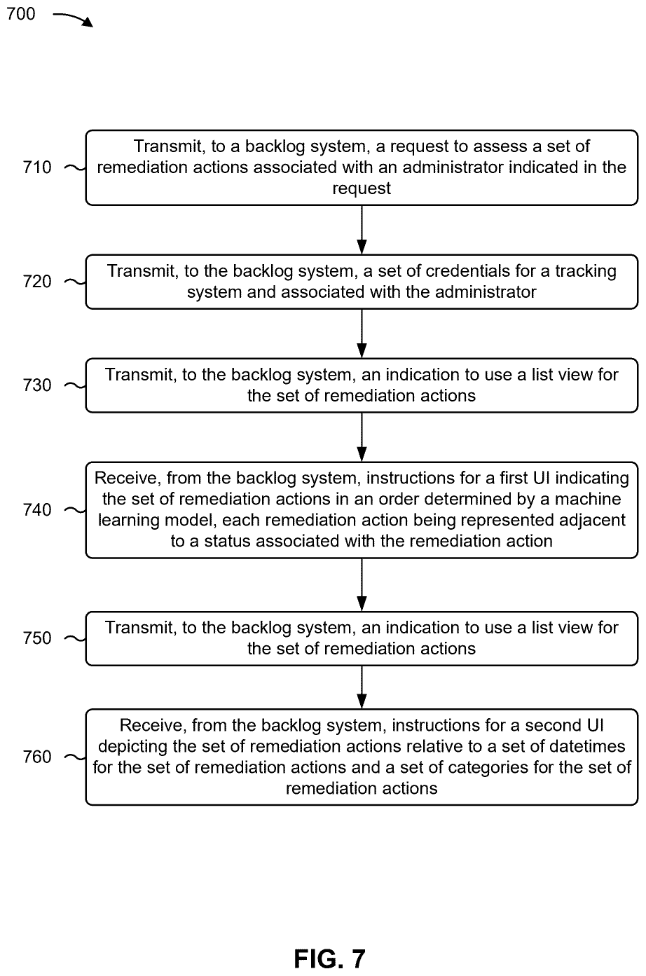

FIG. 7 is a flowchart of an example process 700 associated with outputting UIs for visualizing remediation backlogs. In some implementations, one or more process blocks of FIG. 7 may be performed by an administrator device 430. In some implementations, one or more process blocks of FIG. 7 may be performed by another device or a group of devices separate from or including the administrator device 430, such as a backlog system 401, a cloud provider 440, a tracking system 450, and/or an ML host 460. Additionally, or alternatively, one or more process blocks of FIG. 7 may be performed by one or more components of the device 500, such as processor 520, memory 530, input component 540, output component 550, and/or communication component 560.

As shown in FIG. 7, process 700 may include transmitting, to a backlog system, a request to assess a set of remediation actions associated with an administrator indicated in the request (block 710). For example, the administrator device 430 (e.g., using processor 520, memory 530, and/or communication component 560) may transmit, to a backlog system, a request to assess a set of remediation actions associated with an administrator indicated in the request, as described above in connection with FIG. 1A. As an example, the request may include an HTTP request, an FTP request, and/or an API call.

As further shown in FIG. 7, process 700 may include transmitting, to the backlog system, a set of credentials for a tracking system and associated with the administrator (block 720). For example, the administrator device 430 (e.g., using processor 520, memory 530, and/or communication component 560) may transmit, to the backlog system, a set of credentials for a tracking system and associated with the administrator, as described above in connection with FIG. 1A. As an example, the administrator device 430 may transmit the set of credentials in a same message as the request to assess the set of remediation actions or in a different message. Accordingly, the backlog system may use the set of credentials in order to access a set of data structures associated with the set of remediation actions.

As further shown in FIG. 7, process 700 may include transmitting, to the backlog system, an indication to use a list view for the set of remediation actions (block 730). For example, the administrator device 430 (e.g., using processor 520, memory 530, and/or communication component 560) may transmit, to the backlog system, an indication to use a list view for the set of remediation actions, as described above in connection with FIG. 1C. As an example, the indication may be based on a default setting or input from an administrator (e.g., using input component 540) who is using the administrator device 430.

As further shown in FIG. 7, process 700 may include receiving, from the backlog system, instructions for a first UI indicating the set of remediation actions in an order determined by a machine learning model, each remediation action being represented in the first UI adjacent to a status associated with the remediation action (block 740). For example, the administrator device 430 (e.g., using processor 520, memory 530, and/or communication component 560) may receive, from the backlog system, instructions for a first UI indicating the set of remediation actions in an order determined by a machine learning model, each remediation action being represented in the first UI adjacent to a status associated with the remediation action, as described above in connection with FIG. 2. As an example, the first UI may include a list of the set of respective remediation actions adjacent to a list of a set of statuses (and adjacent to a list of the set of datetimes).

As further shown in FIG. 7, process 700 may include transmitting, to the backlog system, an indication to use a calendar view for the set of remediation actions (block 750). For example, the administrator device 430 (e.g., using processor 520, memory 530, and/or communication component 560) may transmit, to the backlog system, an indication to use a calendar view for the set of remediation actions, as described above in connection with FIG. 1C. As an example, the indication may be based on a default setting or input from an administrator (e.g., using input component 540) who is using the administrator device 430.

As further shown in FIG. 7, process 700 may include receiving, from the backlog system, instructions for a second UI depicting the set of remediation actions relative to a set of datetimes for the set of remediation actions and a set of categories for the set of remediation actions (block 760). For example, the administrator device 430 (e.g., using processor 520, memory 530, and/or communication component 560) may receive, from the backlog system, instructions for a second UI depicting the set of remediation actions relative to a set of datetimes for the set of remediation actions and a set of categories for the set of remediation actions, as described above in connection with FIG. 3. As an example, the set of datetimes may be used to organize columns of the second UI, and the set of categories may be used to organize rows of the second UI.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1D, 2, and/or 3. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for providing user interfaces (UIs) to visualize a remediation backlog, the system comprising:
one or more memories; and
one or more processors, communicatively coupled to the one or more memories, configured to:
receive, from a tracking system, a set of data structures representing a set of respective remediation actions;
determine, for each remediation action, a score representing a level of effort associated with the remediation action;
provide, to a machine learning model, a set of datetimes from the set of data structures, a set of severity levels from the set of data structures, and the score for each remediation action, in order to receive an order for the set of respective remediation actions;
output, to an administrator device, instructions for a first UI indicating the set of respective remediation actions in the order from the machine learning model, wherein each remediation action is represented in the first UI adjacent to a status associated with the remediation action; and
output, to the administrator device, instructions for a second UI depicting the set of respective remediation actions relative to the set of datetimes and a set of categories for the set of respective remediation actions.

2. The system of claim 1, wherein the set of respective remediation actions includes at least one security vulnerability to be remediated.

3. The system of claim 1, wherein the set of respective remediation actions includes at least one compliance activity to be completed.

4. The system of claim 1, wherein the one or more processors are configured to:
receive calendar information associated with at least one administrator, wherein the at least one administrator is assigned to one or more remediation actions in the set of respective remediation actions; and
output, to the administrator device, at least one alert based on the calendar information.

5. The system of claim 1, wherein the one or more processors are configured to:
receive a total score associated with a remediation team; and
output, to the administrator device, an indication of a difference between the total score associated with the remediation team and a summation of scores for the set of respective remediation actions.

6. The system of claim 1, wherein the one or more processors are configured to:
provide the set of data structures to an additional machine learning model in order to receive a suggested combination of two or more remediation actions in the set of respective remediation actions; and
output, to the administrator device, an indication of the suggested combination.

7. The system of claim 6, wherein the suggested combination is associated with an automated script, and the one or more processors are configured to:
execute the automated script; and
transmit, to the tracking system, an instruction to clear one or more tickets associated with the two or more remediation actions.

8. The system of claim 7, wherein the one or more processors are configured to:
receive, from the administrator device, an approval of the suggested combination, wherein the automated script is executed in response to the approval.

9. A method of providing user interfaces (UIs) to visualize a remediation backlog, comprising:
transmitting, from an administrator device and to a backlog system, a request to assess a set of remediation actions associated with an administrator indicated in the request;
transmitting, from the administrator device and to the backlog system, a set of credentials for a tracking system and associated with the administrator;
transmitting, from the administrator device and to the backlog system, an indication to use a list view for the set of remediation actions; and
receiving, from the backlog system and at the administrator device, instructions for a UI indicating the set of remediation actions in an order determined by a machine learning model, wherein each remediation action is represented in the UI adjacent to a status associated with the remediation action.

10. The method of claim 9, wherein the UI further indicates a difference between a total score associated with a remediation team including the administrator and a summation of scores for the set of remediation actions.

11. The method of claim 9, wherein the UI further indicates a difference between a predicted schedule for a remediation team including the administrator and an estimated timeline for the set of remediation actions.

12. The method of claim 9, further comprising:
receiving, from the backlog system and at the administrator device, an indication of a suggested automated script.

13. The method of claim 12, further comprising:
transmitting, to the backlog system and from the administrator device, an approval of the suggested automated script.

14. The method of claim 9, further comprising:
receiving, from the tracking system and at the administrator device, an indication that a ticket, associated with a remediation action in the set of remediation actions, has been cleared by the backlog system.

15. A non-transitory computer-readable medium storing a set of instructions for providing user interfaces (UIs) to visualize a remediation backlog, the set of instructions comprising:
one or more instructions that, when executed by one or more processors of a device, cause the device to:
transmit, to a backlog system, a request to assess a set of remediation actions associated with an administrator indicated in the request;
transmit, to the backlog system, a set of credentials for a tracking system and associated with the administrator;
transmit, to the backlog system, an indication to use a calendar view for the set of remediation actions; and
receive, from the backlog system, instructions for a UI depicting the set of remediation actions relative to a set of datetimes for the set of remediation actions and a set of categories for the set of remediation actions.

16. The non-transitory computer-readable medium of claim 15, wherein the set of remediation actions includes at least one security vulnerability to remediate.

17. The non-transitory computer-readable medium of claim 15, wherein the set of remediation actions includes at least one compliance activity to complete.

18. The non-transitory computer-readable medium of claim 15, wherein the one or more instructions, when executed by the one or more processors, cause the device to:
receive, from the backlog system, an indication of a suggested automated script.

19. The non-transitory computer-readable medium of claim 18, wherein the one or more instructions, when executed by the one or more processors, cause the device to:
transmit, to the backlog system, an approval of the suggested automated script.

20. The non-transitory computer-readable medium of claim 15, wherein the one or more instructions, when executed by the one or more processors, cause the device to:
receive, from the tracking system, an indication that a ticket, associated with a remediation action in the set of remediation actions, has been cleared by the backlog system.
